(19) United States
(12) Patent Application Publication
(10) Pub. No.: US 2017/0066329 A1
(43) Pub. Date: Mar. 9, 2017

(54) OPERATION INPUT DEVICE

(71) Applicant: KABUSHIKI KAISHA TOKAI RIKA DENKI SEISAKUSHO, Aichi (JP)

(72) Inventors: Shuri ARAKAWA, Aichi (JP); Akiko HOSHINO, Aichi (JP)

(73) Assignee: KABUSHIKI KAISHA TOKAI RIKA DENKI SEISAKUSHO, Aichi (JP)

(21) Appl. No.: 15/120,030

(22) PCT Filed: Jan. 26, 2015
(86) PCT No.: PCT/JP2015/052051

§ 371 Date: Aug. 18, 2016

(30) Foreign Application Priority Data
Feb. 20, 2014 (JP) 2014-030393

(51) Int. Cl. B60K 35/00; G06F 3/044; G06F 3/041; G06F 3/0484; G06F 3/0488

(52) U.S. Cl. CPC B60K 35/00; G06F 3/04847; G06F 3/04883; G06F 3/0412; G06F 3/044; G06F 2203/04803; B60K 2350/1032; B60K 2350/1072

(57) ABSTRACT

An operation input device includes an operation detection unit that detects an operation made on an operating surface divided into a plurality of operation regions to which functions executed by a controlled device are assigned and at least one border region located between adjacent operation regions of the plurality of operation regions; and a controller that outputs control information for controlling the controlled device to collectively change states of the functions assigned to operation regions, of the plurality of operation regions, adjacent to a border region, of the at least one border region, in which an operation has been detected, on the basis of a trajectory of the operation detected in the border region.

### TECHNICAL FIELD

The present invention relates to an operation input device.

### BACKGROUND ART

An operation device including an operation panel having an operating surface extending two-dimensionally, and a processing device is known see PTL 1, for example).

The processing device of this operation device can collectively set two independent control parameters for controlling an in-vehicle device, in a state where a first control parameter is set in accordance with a position in a first axis direction on the operating surface and a second control parameter is set in accordance with a position in a second axis direction on the operating surface on the basis of a two-dimensional position specified by a user input on the operating surface of the operation panel.

### CITATION LIST

### Patent Literature

[PTL 1]

JP-A-2013-14212

### SUMMARY OF INVENTION

### Technical Problem

The operation device disclosed in PTL 1 requires an operating surface having at least a surface area based on a length in the first axis direction corresponding to the first control parameter and a length in the second axis direction corresponding to the second control parameter, which makes it difficult to reduce the size of the panel and requires a user to watch the operating surface carefully to make settings, resulting in poor operability.

Thus, an object of the present invention is to provide an operation input device with improved operability.

### Solution to Problem

According to an embodiment of the invention, an operation input device is provided that comprises an operation detection unit that detects an operation made on an operating surface divided into a plurality of operation regions to which functions executed by a controlled device are assigned and at least one border region located between adjacent operation regions of the plurality of operation regions, and a controller that outputs control information for controlling the controlled device to collectively change states of the functions assigned to operation regions, of the plurality of operation regions, adjacent to a border region, of the at least one border region, in which an operation has been detected, on the basis of a trajectory of the operation detected in the border region.

### Advantageous Effects of Invention

According to an embodiment of the invention, an operation input device with improved operability is provided.

### BRIEF DESCRIPTION OF DRAWINGS

FIG. 1A is a schematic diagram illustrating the interior of a vehicle in which a touch panel according to a first embodiment is installed.

FIG. 1B is an exploded perspective view of the touch panel.

FIG. 1C is a schematic diagram illustrating the touch panel, viewed from an operating surface side thereof.

FIG. 2A is a block diagram illustrating the c panel according to e first embodiment.

FIG. 2B is a block diagram illustrating a vehicle communication system to which the touch panel is electromagnetically connected.

FIG. 3A is a schematic diagram illustrating a first trajectory for collectively adjusting a set temperature and an airflow rate through the touch panel according to the first embodiment.

FIG. 3B is a schematic diagram illustrating a second trajectory for collectively adjusting a set temperature and an airflow rate through the touch panel according to the first embodiment.

FIG. 3C is a schematic diagram illustrating a third trajectory for collectively adjusting a set temperature and an airflow rate through the touch panel according to the first embodiment.

FIG. 3D is a schematic diagram illustrating a fourth trajectory for collectively adjusting a set temperature and an airflow rate through the touch panel according to the first embodiment.

FIG. 4A is a schematic diagram illustrating a fifth trajectory for collectively adjusting a set temperature and an airflow rate through the touch panel according to the first embodiment.

FIG. 4B is a schematic diagram illustrating a sixth trajectory for collectively adjusting a set temperature and an airflow rate through the touch panel according to the first embodiment.

FIG. 4C is a schematic diagram illustrating a seventh trajectory for collectively adjusting a set temperature and an airflow rate through the touch panel according to the first embodiment.

FIG. 4D is a schematic diagram illustrating an eighth trajectory for collectively adjusting a set temperature and an airflow rate through the touch panel according to the first embodiment.

FIG. 5 is a flowchart illustrating operations of the touch panel according to the first embodiment.

FIG. 6A is a schematic diagram illustrating a touch panel according to a second embodiment, viewed from an operating surface side thereof.

FIG. 6B is a schematic diagram illustrating a touch panel according to a third embodiment, viewed from an operating surface side thereof.

FIG. 7A is a schematic diagram illustrating operation regions of a touch panel according to a fourth embodiment.

FIG. 7B is a schematic diagram illustrating the trajectory of an operation made in a first border region of a touch pad according to a fifth embodiment.

FIG. 7C is a schematic diagram illustrating the trajectory of an operation made from a first border region up to a second border region.

### DESCRIPTION OF EMBODIMENTS

### Overview of Embodiments

Operation input devices according to embodiments each include: an operation detection unit that detects an operation made on an operating surface divided into a plurality of operation regions to which functions executed by a controlled device are assigned and at least one border region located between adjacent operation regions of the plurality of operation regions; and a controller that outputs control information for controlling the controlled device to collectively change the states of the functions assigned to operation regions, of the plurality of operation regions, adjacent to a border region, of the at least one border region, in which an operation has been detected, on the basis of a trajectory of the operation detected in the border region.

This operation input device can, on the basis of the trajectory of an operation made in the border region, collectively change the states of the functions assigned to the operation regions adjacent to the border region, and thus improves the operability as compared to a case where the operations are carried out separately.

### First Embodiment

### Configuration of Touch Panel 1

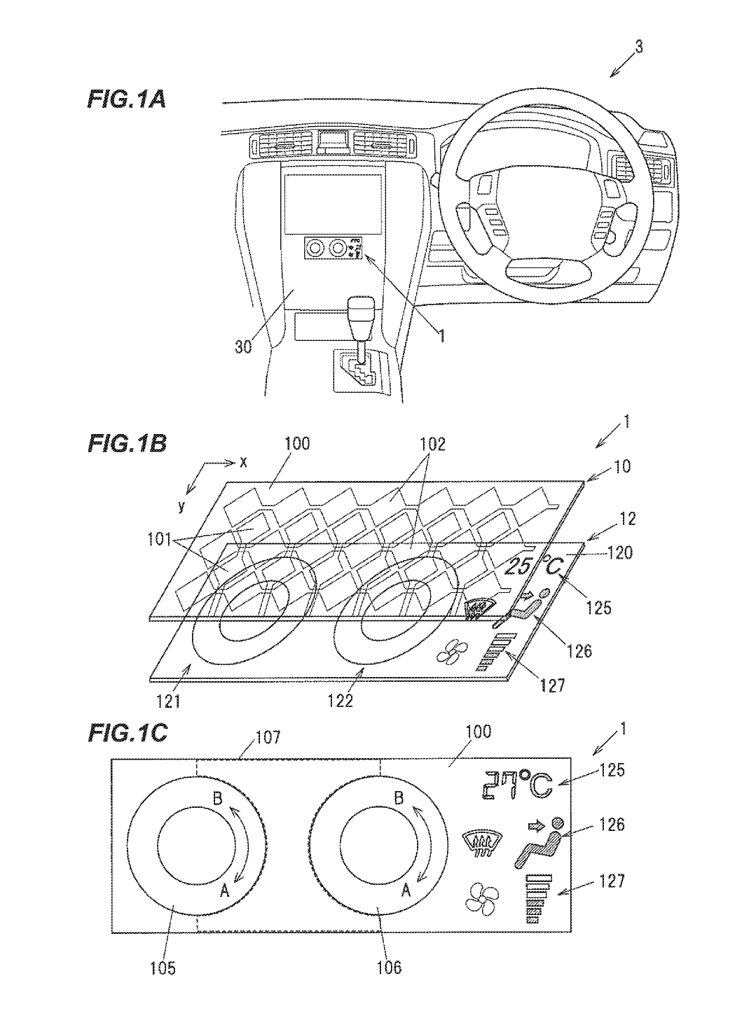

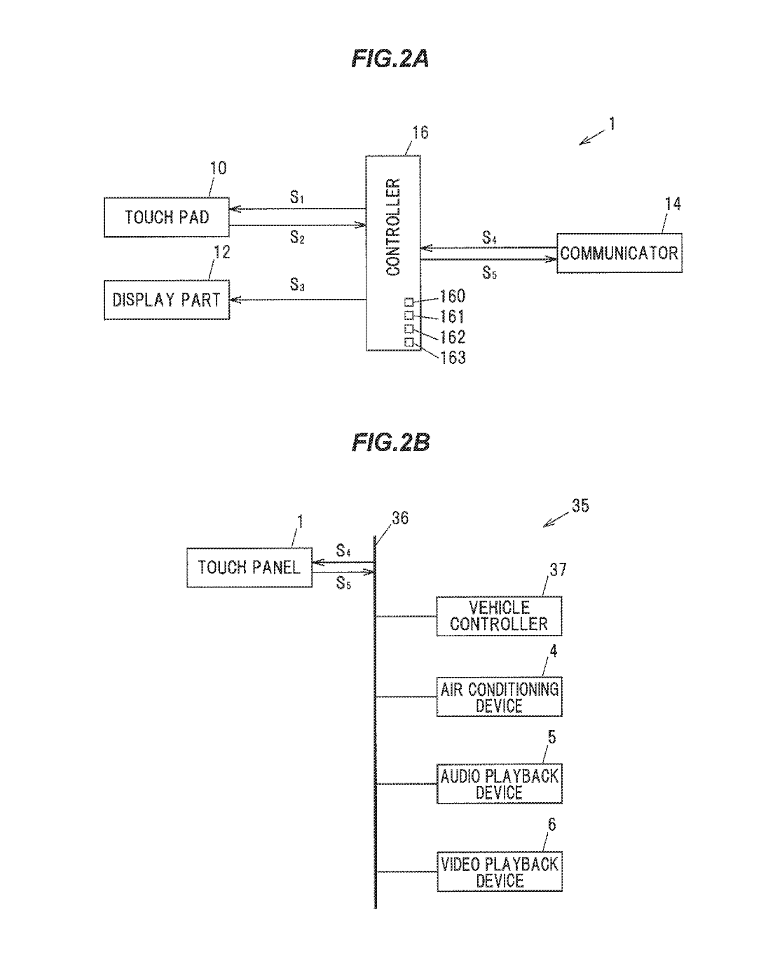

FIG. 1A is a schematic diagram illustrating the interior of a vehicle in which a touch panel according to a first embodiment is installed, FIG. 1B is an exploded perspective view of the touch panel, and FIG. 1C is a schematic diagram illustrating the touch panel viewed from an operating surface side thereof. FIG. 2A is a block diagram illustrating the touch panel according to the first embodiment, and FIG. 2B is a block diagram illustrating a vehicle communication system to which the touch panel is electromagnetically connected. In the drawings associated with the following embodiments, ratios between elements in the drawings may be different from the actual ratios. In addition, in FIGS. 2A and 2B, arrows indicate the flows of primary signals, information, and the like.

A touch panel 1 serving as an operation input device is, as illustrated in FIG. 1A, installed in a center console 30 located between a driver's seat and a passenger's seat of a vehicle 3, for example. As illustrated in FIG. 1B, the touch panel 1 includes a touch pad 10, serving as an operation detection unit, disposed on top of a display part 12. However, the touch panel 1 is not limited to a configuration in which the touch pad 10 is disposed on top of the display part 12, and the two elements may be disposed separate from each other.

As illustrated in FIG. 2B, the touch panel 1 is configured to display a display image 120 based on display image information S4 obtained from an air conditioning device 4 that delivers temperature-controlled air to the interior of the vehicle 3, an audio playback device 5 that plays back audio data recorded in a recording medium, a video playback device 6 that plays back video data recorded in a recording medium, and the like, which serve as electronic devices installed in the vehicle 3. The touch panel 1 is further configured to detect operations made on an operating surface 100 of the touch pad 10. The display image 120 is displayed through the touch pad 10.

As illustrated in FIGS. 1C and 2A, this touch panel 1 includes: the touch pad 10 that detects an operation made on the operating surface 100 divided into a plurality of operation regions to which functions executed by a controlled device are assigned and at least one border region located between adjacent operation regions of the plurality of operation regions; and a controller 16 that outputs control information S5 for controlling the controlled device to collectively change the states of the functions assigned to operation regions, of the plurality of operation regions, adjacent to a border region, of the at least one border region, in which an operation has been detected, on the basis of a trajectory of the operation detected in that border region.

The plurality of operation regions according to the present embodiment are a first operation region 105 and a second operation region 106. The at least one border region according to the present embodiment is a border region 107 located between the first operation region 105 and the second operation region 106.

Here, examples of the controlled device according to the present embodiment include the air conditioning device 4. Examples of the function executed by the controlled device include a function for setting the temperature of air delivered by the air conditioning device 4 to the interior of the vehicle 3, a function for setting the airflow rate of the air being delivered, a function for selecting an air outlet from which. air is delivered, and the like.

“The state of the function assigned” refers, in the case where the assigned function is a function for setting the set temperature, to the set temperature that has been set. Furthermore, in the case where the assigned function is a function for setting the airflow rate, “the state of the function assigned” refers to the airflow rate that has been set. Moreover, in the case where the assigned function is a function for selecting the air outlet, “the state of the function assigned” refers to the air outlet that has been set. When an operation has been made in the border region 107, for example, the touch panel 1 is configured to output, to the air conditioning device 4, the control information S5 for collectively controlling two functions assigned to the first operation region 105 and the second operation region 106.

As a variation, in the case where the controlled device corresponds to the audio playback device 5 and the video playback device 6, the assigned function corresponds, for example, to a function for setting volume and tone of speakers for the driver's seat and the passenger's seat.

### Configuration of Touch Pad 10

The touch pad 10 is a touch sensor that detects a touched position on the operating surface 100 when the operating surface 100 is touched by a part of an operator's body (a finger, for example) or with a dedicated pen, for example. The operator can, for example, operate the connected air conditioning device 4 by operating the operating surface 100.

The touch pad 10 according to the present embodiment is an electrostatic capacitance-type touch sensor that detects changes in current, which is inversely proportional to a distance between an electrode and a finger, produced when the finger approaches the operating surface 100, for example. The touch pad 10 is also a mutual capacitance-type touch sensor capable of detecting operations made on the operating surface 100 by multiple fingers, or in other words, is capable of multi-touch detection.

As illustrated in FIG. 1B, in the touch pad 10, coordinates are set for the operating surface 100. The xy coordinates are orthogonal coordinates, and an origin thereof is at the upper left of the operating surface 100 in the drawing indicated in FIG. 1C, for example.

The touch pad 10 includes a plurality of first electrodes 101 serving as driving electrodes provided below the operating surface 100, and a plurality of second electrodes 102 serving as receiving electrodes. The first electrodes 101 and the second electrodes 102 are transparent electrodes formed of an indium tin oxide (ITO), for example.

The first electrodes 101 are arranged at equal intervals so as to be orthogonal to the x axis indicated in FIG. 1B. The second electrodes 102 are arranged at equal intervals so as to be orthogonal to the y axis. The first electrodes 101 and the second electrodes 102 have shapes in which a plurality of electrodes having rectangular shapes are connected to each other.

As illustrated in FIG. 1B, the touch pad 10 includes six first electrodes 101 and three second electrodes 102. However, the number of the first electrodes 101 and second electrodes 102 can be set as desired according to the specification of the touch pad 10.

The touch pad 10 is electromagnetically connected to the controller 16. The touch pad 10 is configured so that the first electrodes 101 are driven in response to a driving signal S1 outputted from the controller 16 and electrostatic capacitances are read out via the second electrodes 102. The read-out electrostatic capacitances are outputted to the controller 16 as detection information S2.

Note that “electromagnetically connected” described above refers to a connection using at least one of a connection by a conductor, a connection by light, which is a type of electromagnetic wave, and a connection by radio waves, which are a type of electromagnetic wave.

### Configuration of Display Part 12

The display part 12 includes a liquid-crystal display, for example. The display part 12 is electrically connected to the controller 16. The display part 12 is configured to display the display image 120 on the basis of display control information S3 obtained from the controller 16.

As illustrated in FIG. 19, a first knob display region 121, a second knob display region 122, a temperature display region 125, an air outlet display region 126, and an airflow rate display region 127, for example, are displayed in the display part 12. The first knob display region 121 and the second knob display region 128 are, for example, images depicting rotational-type operation knobs.

The first lamb display region 121 is a donut-shaped region displayed on the left side (the passenger's seat side) of the display image 120 in the drawing indicated in FIG. 1B. The first knob display region 121 is, for example, a region through which the set temperature of temperature-controlled air to be delivered to the interior of the vehicle 3 can be changed. The first knob display region 121 is assigned a function for increasing the set temperature when a tracing operation in the clockwise direction indicated in FIG. 1C (the direction of an arrow A) is made on the region of the operating surface 100 where the first knob display region 121 is projected and for decreasing the set temperature when a tracing operation is made in the counterclockwise direction (the direction of an arrow B). This region corresponds to the first operation region 105 illustrated in FIG. 1C.

The second knob display region 122 is a donut-shaped region displayed on the right side (the driver's seat side) of the display image 120 in the drawing indicated in FIG. 1B. The second knob display region 122 is, for example, a region through which the airflow rate of the temperature-controlled air can be changed. The second knob display region 122 is assigned a function for increasing the airflow rate when a tracing operation in the clockwise direction indicated in FIG. 1C (the direction of an arrow A) is made on the region of the operating surface 100 where the second knob display region 122 is projected and for decreasing the airflow rate when a tracing operation is made in the counterclockwise direction (the direction of an arrow B). This region corresponds to the second operation region 106 illustrated in FIG. 1C.

In other words, the operator operates the first operation region 105 in order to adjust the set temperature and operates the second operation region 106 in order to adjust the airflow rate.

Note that in the drawings viewing the touch panel 1 from the operating surface 100 side, the first knob display region 121 and the second knob display region 122 projected on the touch pad 10 correspond to the first operation region 105 and second operation region 106 to be operated in order to execute the respective functions assigned to the first knob display region 121 and the second knob display region 122, and thus only the operation regions are illustrated. The temperature display region 125, the air outlet display region 126, and the airflow rate display region 127 are assumed to be viewed by the operator through the touch pad 10, and are thus given the same names and reference numerals as in FIG. 1B.

The temperature display region 125 is a region that displays the set temperature of the air delivered from an air outlet. The air outlet display region 126 is a region that displays the air outlet from which the temperature-controlled air is being delivered. The airflow rate display region 127 is a region that displays the airflow rate of the air delivered from the air outlet.

### Configuration of Communicator 14

A communicator 14 is electrically connected to the controller 16, and is electromagnetically connected to a vehicle local area network (LAN) 36 of a vehicle communication system 35.

The communicator 14 is configured to obtain the display image information S4 from the controlled device via the vehicle LAN 36 and output the control information S5 obtained from the controller 16 to the controlled device via the vehicle LAN 36.

### Configuration of Controller 16

The controller 16 is, for example, a microcomputer including a central processing unit (CPU) that carries out computations, processes, and the like on obtained data in accordance with a stored program; a random access memory (RAM) and a read only memory (ROM) that are semiconductor memories; and the like. A program for operations of the controller 16, for example, is stored in the ROM. The RAM is used as a storage region that temporarily stores computation results and the like, for example.

The controller 16 is configured to output the control information S5 based on a result of determining a direction of an operation made in one of the adjacent operation regions and a direction of an operation made in the other of the adjacent operation regions on the basis of the trajectory of the operation detected in the border region 107.

In other words, the controller 16 is configured to find the trajectory of the operation and, on the basis of the trajectory that has been found, determine an operation direction in the one operation region where the trajectory starts and an operation direction in the other operation region.

As illustrated in FIG. 2A, the controller 16 includes a threshold 160, accumulated information 161, image information 16, and trajectory information 163.

The controller 16 is configured to compare the detection information S2 obtained from the touch pad 10 with the threshold 160 and calculate coordinates at which an operating finger has been detected on the basis of a result of the comparison.

The controller 16 is configured to store the coordinates at which the operating finger has been detected along with the time of detection as the accumulated information 161.

The controller 16 is configured to store the image information 162 associated with the display image 120 displayed in the display part 12 on the basis of the display image information S4 obtained through the communicator 14. The controller 16 is configured to define the first operation region 105, the second operation region 106, and the border region 107 on the basis of this image information 162 and determine which of the first operation region 105, the second operation region 106, and the border region 107 has the coordinates at which the operating finger has been detected.

Here, the border region 107 corresponds to at least a region sandwiched between the first operation region 105 and the second operation region 106 and extends in the vertical direction in the drawing indicated in FIG. 1C. The configuration may be such that the border region 107 is included in the above-described image information 162, or the border region 107 is predetermined and held in the controller 16.

Additionally, the controller 16 is configured to determine a trajectory of the operating finger on the basis of the obtained detection information S2, the accumulated information 161, and the trajectory information 163. The controller 16 is configured to generate the control information S5 for causing the air conditioning device 4 to execute a function on the basis of the region where an operation has been made and the trajectory of the operation, and output the control information S5 to the air conditioning device 4 through the communicator 14.

Here, in the case where a determination is made to collectively control functions, the controller 16 generates the control information S5 for changing the set temperature and the airflow rate by predetermined amounts. Note that the controller 16 may set the amounts of change on the basis of the length of the trajectory of the operation that has been made.

### Configuration of Vehicle Communication System 35

As illustrated in FIG. 2B, the vehicle communication system 35 includes the vehicle LAN 36, a vehicle controller 37, and the electronic devices installed in the vehicle. Examples of the electronic devices include the air conditioning device 4, the audio playback device 5, and the video playback device 6.

The vehicle controller 37 is a microcomputer including a CPU, a RAM, a ROM, and the like. The vehicle controller 37 controls the vehicle LAN 36.

### Adjustment of Set Temperature and Airflow Rate

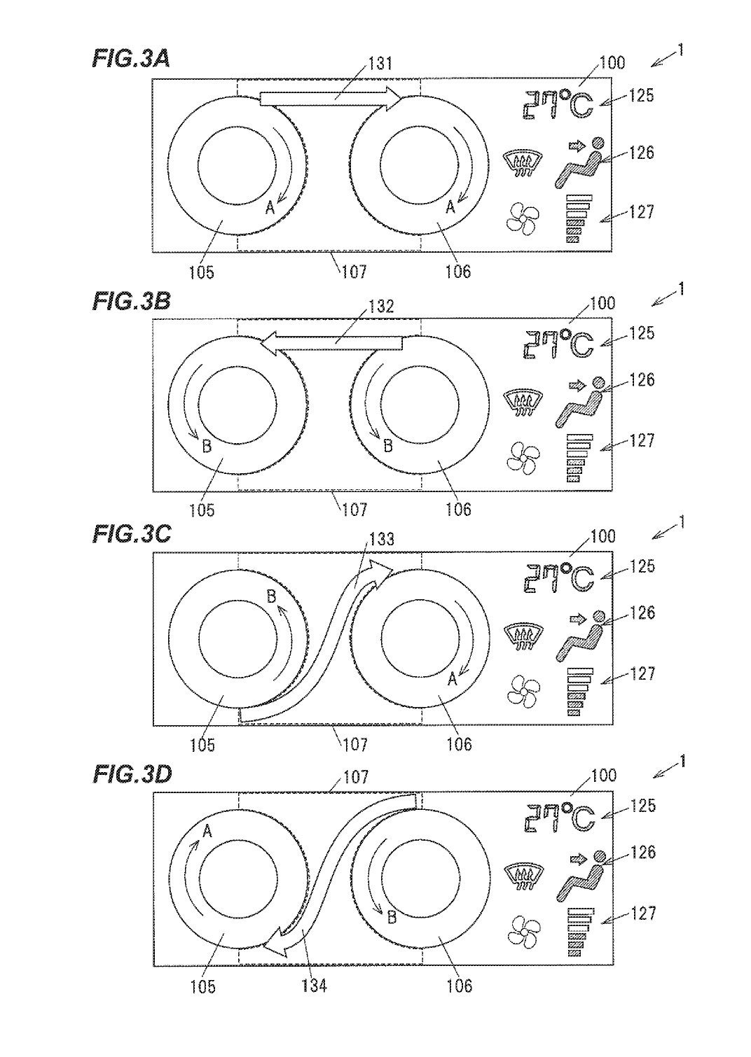

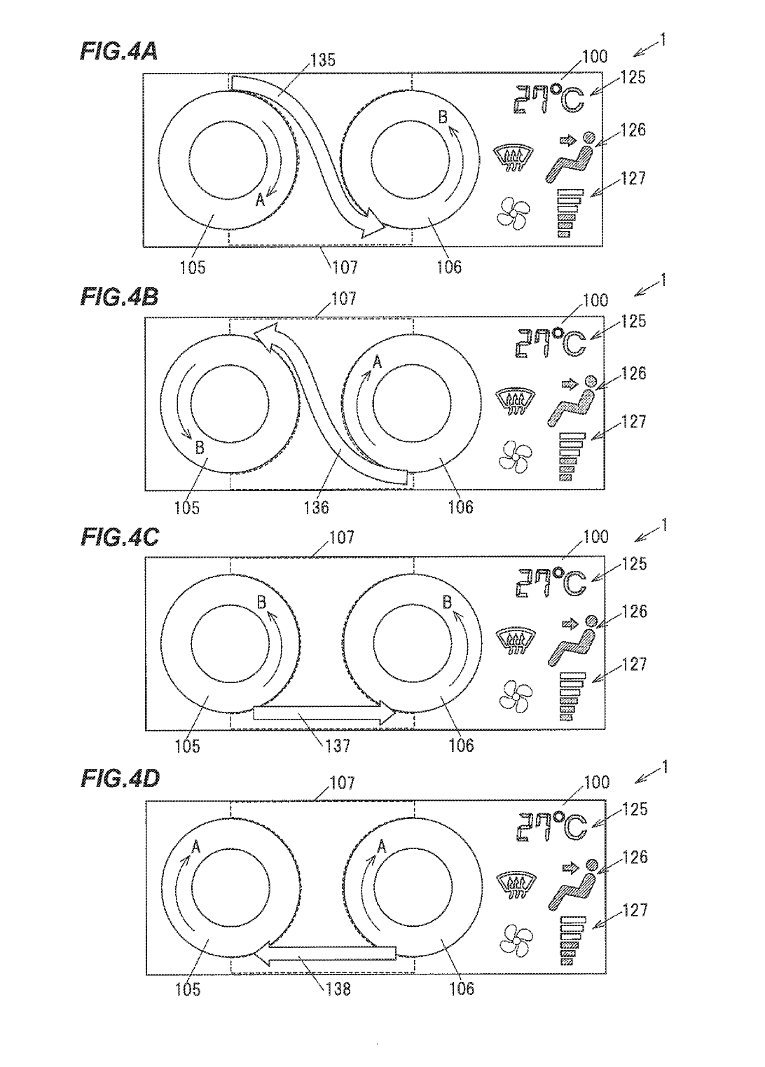

FIGS. 3A to 3D are schematic diagrams illustrating a first trajectory to a fourth trajectory for collectively adjusting the set temperature and the airflow rate through the touch panel according to the first embodiment. FIGS. 4A to 4D are schematic diagrams illustrating a fifth trajectory to an eighth trajectory for collectively adjusting the set temperature and the airflow rate through the touch panel according to the first embodiment.

### First Trajectory 131

A first trajectory 131 is the trajectory of an operation made within the border region 107, from above the first operation region 105 to above the second operation region 106 in the drawing indicated in FIG. 3A. The controller 16 determines the trajectory on the basis of the trajectory of the detected operation and the stored trajectory information 163. In the case where the determined trajectory is the first trajectory 131, the controller 16 generates the control information S5 for increasing the set temperature and the airflow rate.

Specifically, the first trajectory 131 is the trajectory of an operation made from an upper-left side to an upper-right side in the drawing indicated in FIG. 3A, and therefore the operation resembles an operation of tracing the first operation region 105 clockwise (the direction of the arrow A) and tracing the second operation region 106 clockwise (the direction of the arrow A). Accordingly, having determined that the trajectory of the operation that has been made is the first trajectory 131, the controller 16 generates the control information S5 corresponding to that tracing operations have been made in the direction of the arrow A in the first operation region 105 and the second operation region 106.

### Second Trajectory 132

A second trajectory 132 is the trajectory of an operation made within the border region 107, from above the second operation region 106 to above the first operation region 105 in the drawing indicated in FIG. 3B. The controller 16 determines the trajectory on the basis of the trajectory of the detected operation and the stored trajectory information 163. In the case where the determined trajectory is the second trajectory 132, the controller 16 generates the control information S5 for decreasing the set temperature and the airflow rate.

Specifically, the second trajectory 132 is the trajectory of an operation made from an upper-right side to an upper-left side in the drawing indicated in FIG. 3B, and therefore the operation resembles an operation of tracing the first operation region 105 counterclockwise (the direction of the arrow B) and tracing the second operation region 106 counterclockwise (the direction of the arrow B). Accordingly, having determined that the trajectory of the operation that has been made is the second trajectory 132, the controller 16 generates the control information S5 corresponding to that tracing operations have been made in the direction of the arrow B in the first operation region 105 and the second operation region 106. The second trajectory 132 is a trajectory substantially in the direction opposite from the first trajectory 131.

### Third Trajectory 133

A third trajectory 133 is the trajectory of an operation made within the border region 107, from below the first operation region 105 to above the second operation region 106 in the drawing indicated in FIG. 3C. The controller 16 determines the trajectory on the basis of the trajectory of the detected operation and the stored trajectory information 163. In the case where the determined trajectory is the third trajectory 133, the controller 16 generates the control information S5 for decreasing the set temperature and increase the airflow rate.

Here, the trajectory of the operation has been detected in the border region 107, the trajectory extending in a direction orthogonal to the direction in which the adjacent operation regions are arranged, and the controller outputs the control information S5 including a result of determining the direction of the operation made in the one operation region where the trajectory of that operation starts and a result of determining that the direction of the operation made in the other operation region is opposite from the determined direction of the operation made in the one operation region.

Specifically, the third trajectory 133 is the trajectory of an operation made from a lower-left side to an upper-right side in the drawing indicated in FIG. 3C, and therefore the operation resembles an operation of tracing the first operation region 105 counterclockwise (the direction of the arrow B) and tracing the second operation region 106 clockwise (the direction of the arrow A). Accordingly, having determined that the trajectory of the operation that has been made is the third trajectory 133, namely the trajectory of an operation in a direction intersecting the direction in which the adjacent operation regions are arranged, the controller 16 generates the control information S5 corresponding to that tracing operations have been made in the direction of the arrow B in the first operation region 105, which is the one operation region where the third trajectory 133 starts, and in the direction of the arrow A in the second operation region 106, which is the other operation region.

### Fourth Trajectory 134

A fourth trajectory 134 is the trajectory of an operation made within the border region 107, from above the second operation region 106 to below the first operation region 105 in the drawing indicated in FIG. 3D. The controller 16 determines the trajectory on the basis of the trajectory of the detected operation and the stored trajectory information 163. In the case where the determined trajectory is the fourth trajectory 134, the controller 16 generates the control information S5 for increasing the set temperature and decreasing the airflow rate.

Specifically, the fourth trajectory 134 is the trajectory of an operation made from an upper-right side to a lower-left side in the drawing indicated in FIG. 3D, and therefore the operation resembles an operation of tracing the first operation region 105 clockwise (the direction of the arrow A) and tracing the second operation region 106 counterclockwise (the direction of the arrow B). Accordingly, having determined that the trajectory of the operation that has been made is the fourth trajectory 134, the controller 16 generates the control information S5 corresponding to that tracing operations have been made in the direction of the arrow A in the first operation region 105 and in the direction of the arrow B in the second operation region 106. The fourth trajectory 134 is a trajectory substantially in the direction opposite from the third trajectory 133.

### Fifth Trajectory 135

A fifth trajectory 135 is the trajectory of an operation made within the border region 107, from above the first operation region 105 to below the second operation region 106 in the drawing indicated in FIG. 4A. The controller 16 determines the trajectory on the basis of the trajectory of the detected operation and the stored trajectory information 163. In the case where the determined trajectory is the fifth trajectory 135, the controller 16 generates the control information S5 for increasing the set temperature and decreasing the airflow rate.

Specifically, the fifth trajectory 135 is the trajectory of an operation made from an upper-left side toward a lower-right side in the drawing indicated in FIG. 4A, and therefore the operation resembles an operation of tracing the first operation region 105 clockwise (the direction of the arrow A) and tracing the second operation region 106 counterclockwise (the direction of the arrow B). Accordingly, having determined that the trajectory of the operation that has been made is the fifth trajectory 135, the controller 16 generates the control information S5 corresponding to that tracing operations have been made in the direction of the arrow A in the first operation region 105 and in the direction of the arrow B in the second operation region 106.

### Sixth Trajectory 136

A sixth trajectory 136 is the trajectory of an operation made within the border region 107, from below the second operation region 106 to above the first operation region 105 in the drawing indicated in FIG. 4B. The controller 16 determines the trajectory on the basis of the trajectory of the detected operation and the stored trajectory information 163. In the case where the determined trajectory is the sixth trajectory 136, the controller 16 generates the control information S5 for decreasing the set temperature and increasing the airflow rate.

Specifically, the sixth trajectory 136 is the trajectory of an operation made from a lower-left side to an upper-right side in the drawing indicated in FIG. 4B, and therefore the operation resembles an operation of tracing the first operation region 105 counterclockwise (the direction of the arrow B) and tracing the second operation region 106 clockwise (the direction of the arrow A). Accordingly, having determined that the trajectory of the operation that has been made is the sixth trajectory 136, the controller 16 generates the control information S5 corresponding to that tracing operations have been made in the direction of the arrow B in the first operation region 105 and in the direction of the arrow A in the second operation region 106. The sixth trajectory 136 is a trajectory substantially in the direction opposite from the fifth trajectory 135.

### Seventh Trajectory 137

A seventh trajectory 137 is the trajectory of an operation made within the border region 107, from below the first operation region 105 to below the second operation region 106 in the drawing indicated in FIG. 4C. The controller 16 determines the trajectory on the basis of the trajectory of the detected operation and the stored trajectory information 163. In the case where the determined trajectory is the seventh trajectory 137, the controller 16 generates the control information S5 for decreasing the set temperature and the airflow rate.

Specifically, the seventh trajectory 137 is the trajectory of an operation made from a lower-left side to a lower-right side in the drawing indicated in FIG. 4C, and therefore the operation resembles an operation of tracing the first operation region 105 counterclockwise (the direction of the arrow B) and tracing the second operation region 106 counterclockwise (the direction of the arrow B). Accordingly, having determined that the trajectory of the operation that has been made is the seventh trajectory 137, the controller 16 generates the control information S5 corresponding to that tracing operations have been made in the direction of the arrow B in the first operation region 105 and the second operation region 106.

### Eighth Trajectory 138

An eighth trajectory 138 is the trajectory of an operation made within the border region 107, from a lower side of the second operation region 106 toward a lower side of the first operation region 105 in the drawing indicated in FIG. 4D. The controller 16 determines the trajectory on the basis of the trajectory of the detected operation and the stored trajectory information 163. In the case where the determined trajectory is the eighth trajectory 138, the controller 16 generates the control information S5 for increasing the set temperature and the airflow rate.

Specifically, the eighth trajectory 138 is the trajectory of an operation made from a lower-right side to a lower-left side in the drawing indicated in FIG. 4D, and therefore the operation resembles an operation of tracing the first operation region 105 clockwise (the direction of the arrow A) and tracing the second operation region 106 clockwise (the direction of the arrow A). Accordingly, having determined that the trajectory of the operation that has been made is the eighth trajectory 138, the controller 16 generates the control information S5 corresponding to that tracing operations have been made in the direction of the arrow A in the first operation region 105 and the second operation region 106. The eighth trajectory 138 is a trajectory substantially in the direction opposite from the seventh trajectory 137.

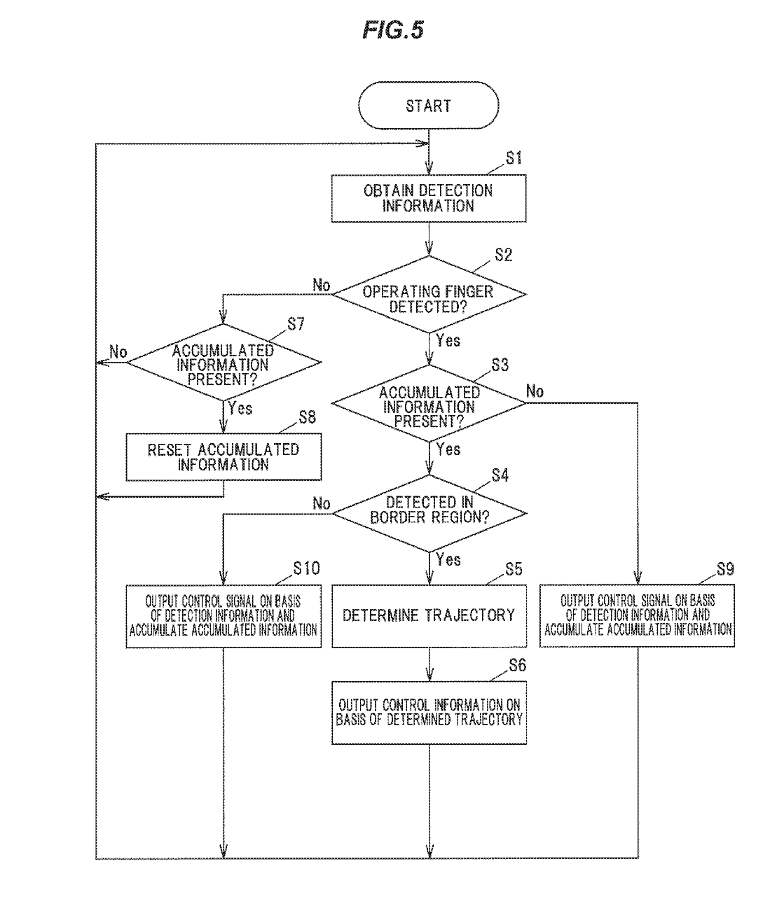

Operations of the touch panel according to the present embodiment will be described hereinafter according to the flowchart illustrated in FIG. 5, with reference to the other drawings as well.

### Operation

After the power of the vehicle 3 is turned on, the controller 16 of the touch panel 1 generates the driving signal S1 and outputs the driving signal S1 to the touch pad 10, and periodically obtains the detection information S2 (S1).

The controller 16 compares the obtained detection information S2 with the threshold 160 to determine whether or not an operating finger has been detected, Upon the operating finger being detected (Yes in S2), the controller 16 determines whether or not an operating finger was detected in a previous period on the basis of the accumulated information 161.

In the case where there is accumulated information 161 (Yes in S3), the controller 16 determines whether or not the detected operating finger is located within the border region 107.

In the case where the operating finger has been detected within the border region 107 (Yes in S4), the controller 16 determines the trajectory on the basis of the trajectory information 163 (S5).

The controller 16 generates the control information S5 on the basis of the determined trajectory and outputs the control information S5 to the vehicle communication system 35 through the communicator 14 (S6), and resets the accumulated information 161 (S7). Next, the controller 16 returns to step 1 and obtains the detection information S2.

In the case where the determined trajectory is the first trajectory 131, the air conditioning device 4 increases the set temperature and the airflow rate on the basis of the obtained control information S5.

In the case where the operating finger has not been detected in step 2 (No in S2), the controller 16 confirms whether or not there is accumulated information 161. In the case where there is accumulated information 161 (Yes in S7), the controller 16 resets the accumulated information 161 (S8), returns to step 1, and obtains the detection information 52. In the case where there is no accumulated information 161 (No in S7), the controller 16 returns to step 1 and obtains the detection information S2.

In step 3, in the case where the operating finger has been detected but there is no accumulated information 161 (No in S3), the controller 16 generates the control information S5 on the basis of the detection information S2 and outputs the control information S5 to the vehicle communication system 35 through the communicator 14, and accumulates information including the coordinates where the operating finger was detected as the accumulated information 161 (S9).

In step 4, in the case where the operating finger has been detected, and there is accumulated information 161 but the operation has not been made in the border region 107 (No in S4), the controller 16 generates the control information S5 on the basis of the detection information S2 and outputs the control information S5 to the vehicle communication system 35 through the communicator 14, and accumulates information including the coordinates where the operating finger was detected as the accumulated information 161 (S10).

The controller 16 continually executes this series of processes until the power is turned off.

### Effect of First Embodiment

The touch panel 1 according to the present embodiment can improve operability. Specifically, the touch panel 1 can collectively change the states of functions assigned to the first operation region 105 and the second operation region 106 adjacent to the border region 107 on the basis of the trajectory of an operation made in the border region 107, thus reducing the operating burden and improving the operability as compared to a case where the operations are carried out separately.

Additionally, the touch panel 1 can, for example, adjust the set the aperture and the airflow rate with a single tracing operation, which shortens the time required for input as compared to a case where the adjustments are made separately.

The touch panel 1 can be operated intuitively without requiring the operator to remember complicated operations, and can suppress the movement of the operator's line of sight relative to the touch panel 1.

### Second Embodiment

A second embodiment differs from the above-described embodiment in that the first operation region 105 and the second operation region 106 are arranged vertically.

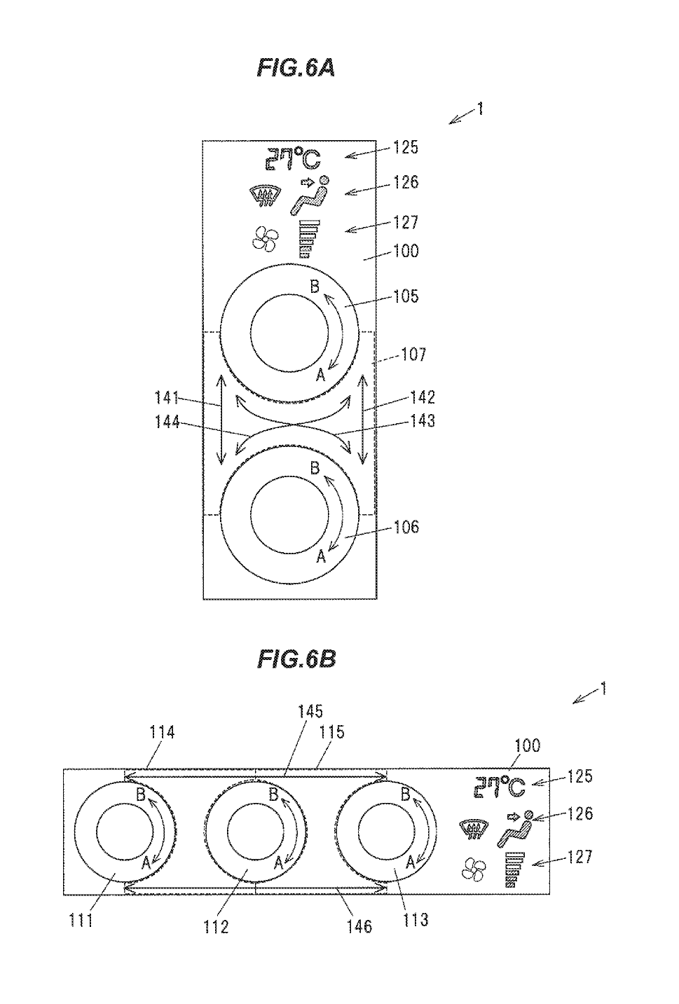

FIG. 6A is a schematic diagram illustrating a touch panel according to the second embodiment, viewed from an operating surface side thereof. In FIG. 6A, trajectories oriented in mutually different directions are indicated by a double-headed arrow oriented in two directions. In the embodiments described below, parts having the same functions and configurations as in the first embodiment will be given the same reference numerals as in the first embodiment, and descriptions thereof will be omitted.

As illustrated in FIG. 6A, in the touch panel 1 according to the present embodiment, the first operation region 105 and the second operation region 106 are arranged in a single row in the vertical direction.

The first operation region 105 is an operation region in which the set temperature increases when the region is operated clockwise (in the direction of the arrow A) in the drawing indicated in FIG. 6A and the set temperature decreases when the region is operated counterclockwise (in the direction of the arrow B). The second operation region 106 is an operation region in which. the airflow rate increases when the region is operated clockwise (in the direction of the arrow A) in the drawing indicated in FIG. 6A and the airflow rate decreases when the region is operated counterclockwise (in the direction of the arrow B).

In FIG. 6A, one trajectory of an operation made from a region on the left side of the first operation region 105 to a region on the left side of the second operation region 106, and the other trajectory in the opposite direction therefrom, are indicated as a first trajectory group 141. The one trajectory is a trajectory in which the first operation region 105 is operated in the direction of the arrow B and the second operation region 106 is operated in the direction of the arrow B. The other trajectory is a trajectory in which the second operation region 106 is operated in the direction of the arrow A and the first operation region 105 is operated in the direction of the arrow A.

Additionally, in FIG. 6A, one trajectory of an operation made from a region on the right side of the first operation region 105 to a region on the right side of the second operation region 106, and the other trajectory in the opposite direction therefrom, are indicated as a second trajectory group 142. The one trajectory is a trajectory in which the first operation region 105 is operated in the direction of the arrow A and the second operation region 106 is operated in the direction of the arrow A. The other trajectory is a trajectory in which the second operation region 106 is operated in the direction of the arrow B and the first operation region 105 is operated in the direction of the arrow B.

Additionally, in FIG. 6A, one trajectory of an intersecting operation made from a region on the left side of the first operation region 105 to a region on the right side of the second operation region 106, and the other trajectory in the opposite direction therefrom, are indicated as a third trajectory group 143. The one trajectory is a trajectory in which the first operation region 105 is operated in the direction of the arrow B and the second operation region 106 is operated in the direction of the arrow A. The other trajectory is a trajectory in which the second operation region 106 is operated in the direction of the arrow B and the first operation region 105 is operated in the direction of the arrow A.

Furthermore, in FIG. 6A, one trajectory of an intersecting operation made from a region on the right side of the first operation region 105 to a region on the left side of the second operation region 106, and the other trajectory in the opposite direction therefrom, are indicated as a fourth trajectory group 144. The one trajectory is a trajectory in which the first operation region 105 is operated in the direction of the arrow A and the second operation region 106 is operated in the direction of the arrow B. The other trajectory is a trajectory in which the second operation region 106 is operated in the direction of the arrow A and the first operation region 105 is operated in the direction of the arrow B.

The controller 16 generates and outputs the control information S5 on the basis of a determination of the above-described trajectories.

### Third Embodiment

A third embodiment differs from the above-described embodiments in that a first operation region 111 to a third operation region 113 are provided.

FIG. 6B is a schematic diagram illustrating a touch panel according to the third embodiment, viewed from an operating surface side thereof. In the touch panel 1 according to the present embodiment, the first operation region 111 to the third operation region 113 are arranged in a single row in the horizontal direction in the drawing indicated in FIG. 6B. A first border region 114 is formed between the first operation region 111 and the second operation region 112. Furthermore, a second border region 115 is formed between the second operation region 112 and the third operation region 113.

FIG. 6B indicates a first trajectory group 145 and a second trajectory group 146 that include trajectories aside from the trajectories of the above-described operations. The first trajectory group 145 and the second trajectory group 146 correspond to trajectories of operations that span the first border region 114 and the second border region 115.

Specifically, in FIG. 6B, one trajectory that traverses a region on the upper side of the first operation region 111, a region on the upper side of the second operation region 112, and a region on the upper side of the third operation region 113, and the other trajectory in the opposite direction therefrom, are indicated as the first trajectory group 145. The one trajectory is a trajectory in which the first operation region 111 to the third operation region 113 are operated in the direction of the arrow A. The other trajectory is a trajectory in which the first operation region 111 to the third operation region 113 are operated in the direction of the arrow B.

Additionally, in FIG. 6B, one trajectory that traverses a region on the lower side of the first operation region 111, a region on the lower side of the second operation region 112, and a region on the lower side of the third operation region 113, and the other trajectory in the opposite direction therefrom, are indicated as the second trajectory group 146. The one trajectory is a trajectory in which the first operation region 111 to the third operation region 113 are operated in the direction of the arrow B. The other trajectory is a trajectory in which the first operation region 111 to the third operation region 113 are operated in the direction of the arrow A.

In the case where a trajectory corresponding to the first trajectory group 145 and the second trajectory group 146, spanning the first border region 114 and the second border region 115, has been determined, the controller 16 generates and outputs the control information S5 on the basis of the direction of the above-described operation.

The controller 16 determines the trajectory of an operation made in the first border region 114 and the trajectory of an operation made in the second border region 115 in the same manner as in the above-described embodiments, and generates and outputs the control information S5.

### Fourth Embodiment

A fourth embodiment differs from the above-described embodiments in that a plurality of operation regions are disposed as concentric circles.

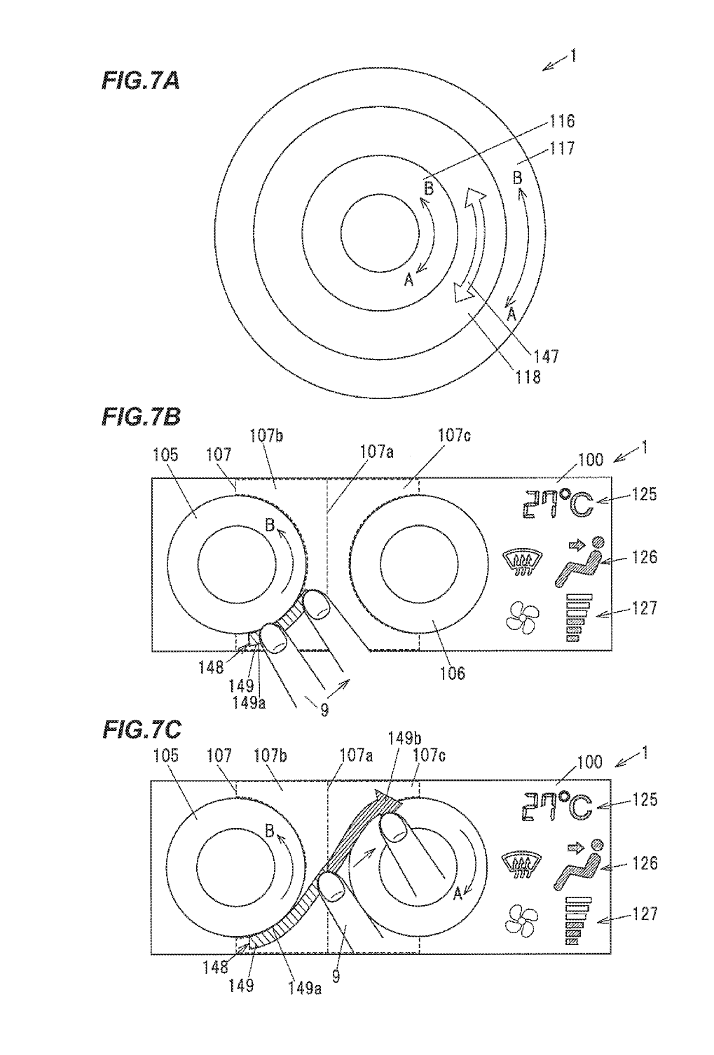

FIG. 7A is a schematic diagram illustrating operation regions of a touch panel according to the fourth embodiment. As illustrated in FIG. 7A, in the touch panel 1 according to the present embodiment, a first operation region 116 and a second operation region 117 are disposed as concentric circles having a common center, and a border region 118 is formed between the first operation region 116 and the second operation region 117.

The first operation region 116 is, for example, an operation region in which the set temperature increases when the region is operated clockwise (in the direction of the arrow A) in the drawing indicated in FIG. 7A and the set temperature decreases when the region is operated counterclockwise (in the direction of the arrow B).

The second operation region 117 is, for example, an operation region in which the airflow rate increases when the region is operated clockwise (in the direction of the arrow A) in the drawing indicated in FIG. 7A and the airflow rate decreases when the region is operated counterclockwise (in the direction of the arrow B).

In FIG. 7A, one trajectory of an operation made clockwise in the border region 118, and the other trajectory in the direction opposite therefrom, are indicated as a trajectory group 147. The one trajectory is a trajectory in which the first operation region 116 and the second operation region 117 are operated in the direction of the arrow A as a result of a clockwise operation along the border region 118. The other trajectory is a trajectory in which the first operation region 116 and the second operation region 117 are operated in the direction of the arrow B as a result of a counterclockwise operation along the border region 118.

The controller 16 makes the same determination as those made in the above-described embodiments on the basis of the trajectory of the operation made along the border region 118, and generates and outputs the control information S5.

### Fifth Embodiment

A fifth embodiment differs from the above-described embodiments in that a trajectory 148 is displayed in the display part as a trajectory image 149.

FIG. 7B is a schematic diagram illustrating the trajectory of an operation made in a first border region of a touch pad according to the fifth embodiment, and FIG. 7C is a schematic diagram illustrating the trajectory of an operation made from the first border region across a second border region.

The controller 16 according to the present embodiment is configured to output the control information S5 including information for displaying the trajectory 148 of an operation as the trajectory image 149 in the display part 12.

Additionally, the controller 16 is configured to divide the trajectory of the operation into first trajectory corresponding to an operation in one operation region and a second trajectory corresponding to an operation in the other operation region, and switch between displaying the trajectory image 149 as a first trajectory image 149a and a second trajectory image 149b in accordance with a switch between the first trajectory and the second trajectory.

Specifically, the controller 16 sets a border 107a in the center of the border region 107 between the first operation region 105 and the second operation region 106, and divides the border region 107 into a first border region 107b on a first operation region 105 side and a second border region 107c on a second operation region 106 side.

For example, in the case where an operation has been made from a region on the lower side of the first operation region 105 to a region on the upper side of the second operation region 106 in the drawings indicated in FIGS. 7B and 7C, the controller 16 displays the first trajectory image 149a in the display part 12 while an operating finger 9 is located in the first border region 107b, and displays the second trajectory image 149b in the display part 12 continuing from the first trajectory image 149a while the operating finger 9 is located in the second border region 107c.

The first trajectory image 149a and the second trajectory image 149b form the trajectory image 149. Additionally, the first trajectory image 149a is given a different color, pattern, or the like from the second trajectory image 149b, and is thus configured to be identifiable.

In other words, while the operating finger 9 is located in the first border region 107b, the first trajectory image 149a is displayed assuming that the first operation region 105 is being operated, and the state of a function assigned to the first operation region 105 is changed. When the operating finger 9 moves and is located in the second border region 107c, the state of the function of the first operation region 105 and the state of a function of the second operation region 106 are collectively changed.

Accordingly, the operating finger 9 changes the state of the function of the first operation region 105 while the first trajectory image 149a is being displayed, and collectively changes the state of the function of the first operation region 105 and the state of the function of the second operation region 106 when the second trajectory image 149b is displayed.

According to the touch panel 1 of the present embodiment, whether or not the states are being collectively changed can be determined by the trajectory image 149 displayed in the display part 12, which makes it easy for the operator to recognize whether or not the states are being collectively changed and improves the operability.

According to the touch panel 1 of at least one of the embodiments described above, the operability can be improved.

Note that the shapes of the operation regions according to the above-described embodiments are not limited to donut shapes, and may be different shapes, such as ovals, according to the specification of the connected electronic device. The operation regions may be rectangular, and may be different shapes according to the specification of the connected electronic device.

Although several embodiments of the present invention and modifications thereof have been described above, these embodiments and modifications are merely examples, and the invention according to claims is not intended to be limited thereto. Such novel embodiments and modifications can be implemented in various other forms, and various omissions, substitutions, changes, and the like can be made without departing from the spirit and scope of the present invention. In addition, all combinations of the features described in these embodiments and modifications are not necessary to solve the problem. Furthermore, these embodiments and modifications are included within the spirit and scope of the invention and also within the invention described in the claims and the scope of equivalents thereof.

### INDUSTRIAL APPLICABILITY

The present invention can be applied in operation input devices for operating in-vehicle devices such as air conditioning devices, and audio devices.

### REFERENCE SIGNS LIST

1 Touch Panel
3 Vehicle
4 Air Conditioning Device
5 Audio Playback Device
6 Video Playback Device
9 Operating Finger
10 Touch Pad
12 Display Part
14 Communicator
16 Controller
30 Center Console
35 Vehicle Communication System
36 Vehicle LAN
37 Vehicle Controller
100 Operating Surface
101 First Electrode
102 Second Electrode
105 First Operation Region
106 Second Operation Region
107 Border Region
107a Border
107b First Border Region
107c Second Border Region
111 First Operation Region
112 Second Operation Region
113 Third Operation Region
114 First Border Region
115 Second Border Region
116 First Operation Region
117 Second Operation Region
118 Border Region
120 Display Image
121 First Knob Display Region
122 Second Knob Display Region
125 Temperature Display Region
126 Air Outlet Display Region
127 Airflow Rate Display Region
131 First Trajectory
132 Second Trajectory
133 Third Trajectory
134 Fourth Trajectory
134 Fifth Trajectory
136 Sixth Trajectory
137 Seventh Trajectory
138 Eighth Trajectory
141 First Trajectory Group
142 Second Trajectory Group
143 Third Trajectory Group
144 Fourth Trajectory Group
145 First Trajectory Group
146 Second Trajectory Group
147 Trajectory Group
148 Trajectory
149 Trajectory Image
149a First Trajectory Image
149b Second Trajectory Image
160 Threshold
161 Accumulated Information
162 Image Information
163 Trajectory Information

1. An operation input device, comprising:
an operation detection unit that detects an operation made on an operating surface divided into a plurality of operation regions to which functions executed by a controlled device are assigned and at least one border region located between adjacent operation regions of the plurality of operation regions; and
a controller that outputs control information for controlling the controlled device to collectively change states of the functions assigned to operation regions, of the plurality of operation regions, adjacent to a border region, of the at least one border region, in which an operation has been detected, on the basis of a trajectory of the operation detected in the border region.

2. The device according to claim 1, wherein the controller outputs the control information based on a result of determining a direction of an operation made in one of the adjacent operation regions and a direction of an operation made in another of the adjacent operation regions on the basis of the trajectory of the operation detected in the border region.

3. The device according to claim 1, wherein a trajectory of an operation in a direction orthogonal to an arrangement direction of the adjacent operation regions is detected in the border region, and the controller outputs the control information including a result of determining a direction of an operation made in one of the adjacent operation regions on a starting side of the trajectory of the operation and a result of determining a direction of an operation made in another of the adjacent operation regions is opposite from the direction of the operation made in the one of the adjacent operation regions.

4. The device according to claim 1, wherein the operation detection unit comprises a touch panel attached to or disposed in a vehicle.

5. The device according to claim 4, wherein the touch panel comprises a display part that displays the plurality of operation regions.

6. The device according to claim 2, wherein the states of the functions each include control value used to control the controlled device; and when the direction of the operation made in the one of the adjacent operation regions and the direction of the operation made in the other of the adjacent operation regions are parallel to a lengthwise direction of the operating surface of the operation detection unit, both of the control values assigned to the one of the adjacent operation regions and the other of the adjacent operation regions increase or decrease.

7. The device according to claim 2, wherein the states of the functions each include a control value used to control the controlled device; and when the direction of the operation made in the one of the adjacent operation regions and the direction of the operation made in the other of the adjacent operation regions are not parallel to a lengthwise direction of the operating surface of the operation detection unit, the control values assigned to the one of the adjacent operation regions and the other of the adjacent operation regions vary, that is increase or decrease, inversely with each other.

8. The device according to claim 6, wherein the one of the adjacent operation regions and the other of the adjacent operation regions are disposed along the lengthwise direction of the operating surface.

9. The device according to claim 7, wherein the one of the adjacent operation regions and the other of the adjacent operation regions are disposed along the lengthwise direction of the operating surface.
